(19) United States
(12) Patent Application Publication
(10) Pub. No.: US 2013/0307796 A1
(43) Pub. Date: Nov. 21, 2013

(54) Touchscreen Device Integrated Computing System And Method

(71) Applicants: Chi-Chang Liu, Concord, CA (US); Philip Liu, Concord, CA (US); Young-Ming Wu, Concord, CA (US)

(72) Inventors: Chi-Chang Liu, Concord, CA (US); Philip Liu, Concord, CA (US); Young-Ming Wu, Concord, CA (US)

(21) Appl. No.: 13/792,220

(22) Filed: Mar. 11, 2013

Related U.S. Application Data
(63) Continuation-in-part of application No. 13/472,497, filed on May 16, 2012.

(51) Int. Cl. G06F 3/041

(52) U.S. Cl. CPC G06F 3/041
USPC 345/173

(57) ABSTRACT

System integrating one or more touchscreen devices into a general-purpose non-session based computing system for greater usability and productivity is provided. Methods for operating such system are also provided. A handheld multi-mode input device supporting the methods and the system to achieve the objects is also provided.

### FIELD OF THE INVENTION

The invention relates to a non-session based computing system with one or more touchscreen input devices integrated. More specifically, this invention relates to a touchscreen device integrated non-session based computing system and the method of using it for improved usability and productivity, especially when a multi-mode hand-held input device is used in a concerted fashion.

### BACKGROUND

The convenience, intuitive nature and space-saving advantages over the traditional keyboard and mouse human input methods have made touchscreen a standard feature in many modern consumer electronics and personal computing devices, especially in smart phones.

Additional to the relatively high production cost, however, present touchscreen technology is not suitable for all applications or products. The very essence of the present touchscreen implementation that forces users to stay in close proximity facing the screen and requires users to raise their arms to touch the screen for each operation confines its preferred applications to mostly (a) where the device itself is small and portable; for example: smart phones and portable GPS navigation devices, (b) when user input design is simple, input activity is less frequently or input operation generally over a very limited time period; for example: kiosk monitors, e-reader or electronic whiteboards, or (c) where the operation simplicity factor supersedes all other product features; for example: iPad tablets.

In a few known special cases, such as the Samsung Galaxy Note 2 smart phone and the Samsung ATIV Smart PC slate computer, more than one touchscreen technologies are implemented on the same display surface to offer both the convenient finger touch input and the precise digitizer pen input. However, due to the ambiguity in their implementation and the lack of clear selection guidance, users may not know which particular method is best suited for the task at hand. Consequently, not only the features are not fully utilized, user may get frustrated from using the sub-optimal method for a particular task.

Not all touchscreen modules have a touch-sensitive display surface. So-called virtual touchscreens may use light-detection and image processing technologies to first detect and track an invisible light dot on a projector screen produced when a stylus touches the screen and then translate the light dot position into the projector's image coordinate as the stylus touch input position. In comparison, virtual touchscreens are less precise and limited in spatial resolution, but they are cheaper to make, easy to set up and may work with a very large projection screen, especially when a projector system is already in place.

Attempts to integrate a touchscreen unit into a general purpose computing system have also been made. For example, some of the high-end all-in-one computers and the slate computers replace the traditional display unit with a touchscreen display unit. However, the execution performance and the functionality of the application is hardly enhanced by the use of the touchscreen unit. Another popular approach called session-based network computing, such as the remote desktop or the virtual machine technology, allows a touchscreen device, such as a smart phone or an iPad tablet, for example, to access and execute non-native, computationally expensive applications hosted on a remotely connected computer as if they were executed locally without system integration. That is, for example, in a typical remote desktop session, a session-based client-server configuration is set up between the local touchscreen device and a host computer. While the screen content, completely determined by the session application executed on the server computer, is either sent from the server or reconstructed and rendered locally on the client screen, the user inputs to the local touchscreen device are transmitted to the server host computer to control the application remotely. Although the remote desktop application has significantly expanded the potential use of the smart phones and the tablet computers and lifted the limitations set by their native computing power, several problems and deficiencies exist with the present remote desktop technology and implementation, especially when network infrastructure is involved. For example: (a) because the application can't assume the performance and reliability level of the supporting network infrastructure, bi-directional real-time communication techniques such as hand-shaking are intentionally avoided, thus significantly limits the range of the applications. (b) Because each client-server connection is initiated independently by the client, displaying synchronized content on multiple clients' devices can't be guaranteed without a dedicated fail-proof network infrastructure between the server host and all the client devices. (c) Regardless of its power and availability, the client CPU is not utilized by the remote desktop application other than aiding the local display rendering. And, (d) direct communication between two client devices participating in the same remote desktop application is not possible.

As the built-in CPU of some of the more software-friendly touchscreen devices, such as the iPad and the high end smart phones, become more and more powerful, their application potential is rapidly expanding. However, additional to the previously identified issues, most users have realized that it can be very frustrating to run productivity software on these devices without using a stylus because the touching finger not only blocks the point of interest on the screen but also falls short of the level of control accuracy required for running the software efficiently. Thus, a dedicated off-screen-operated device like a pen mouse seems necessary when accurate point-of-interest control is desired even for a touchscreen device.

### PURPOSE OF THE INVENTION

Therefore, it is an objective of this present invention is to provide a general purpose non-session based computing system integrating one or more touchscreen devices into a traditional computing system for greater usability, flexibility and performance.

Another objective of this present invention is to provide a method for operating such a non-session based touchscreen device integrated computing system.

Another objective of the present invention is to provide a device that can be used for both touchscreen operation and non-touchscreen cursor control without the loss of convenience or ergonomics so as to further enhance the user experience when operating with a touchscreen device.

### BRIEF SUMMARY OF THE INVENTION

System integrating one or more touchscreen devices into a general-purpose non-session based computing system for greater usability and productivity is provided. Methods for operating such system are also provided. A handheld multi-mode input device supporting the methods and the system to achieve the goals is also provided.

### BRIEF DESCRIPTION OF THE DRAWINGS

FIG. 1 shows an exemplary embodiment of the invention for a touchscreen integrated computing system.

FIG. 2 shows details of the exemplary embodiment in FIG. 1 for an electronic document processing application.

FIG. 3 shows another exemplary embodiment of the invention for a touchscreen integrated computing system.

FIG. 4 shows an exemplary application of the embodiment of FIG. 3.

FIG. 5 shows another exemplary embodiment of the invention for a collaborative design application.

FIG. 6 shows another exemplary embodiment of the invention for a computer gaming application.

FIG. 7 shows another exemplary embodiment of the invention with a multi-mode stylus mouse input device.

FIG. 8 shows an exemplary embodiment of the stylus mouse in FIG. 7.

FIG. 9 shows another exemplary embodiment of the stylus mouse in FIG. 7.

### DETAILED DESCRIPTION OF THE DRAWINGS

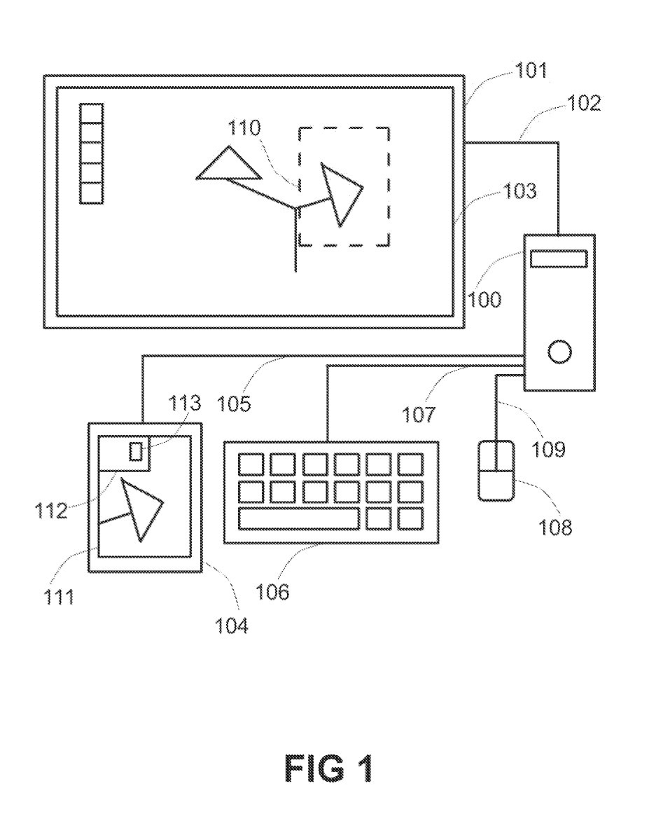

FIG. 1 shows an exemplary embodiment of the present invention. A larger size display unit 101 is operationally connected to CPU 100 by link 102, which may be a wireless link, a fiber optical cable, or an electrical conducting cable, for example. A memory unit, not shown in the drawing, is in the same housing as CPU 100. A touchscreen device 104 is connected to the CPU 100 by link 105, which may be wired or wireless. CPU 100 is also connected to a keyboard 106 by link 107, which may be wired or wireless, and to a mouse 108 by link 109, which may be wired or wireless. A graphics processing unit (GPU), which is not shown in FIG. 1, is housed in and operationally connected to CPU 100 for generating the display content of screen 103 of display unit 101. Alternatively, without a dedicated GPU, CPU 100 may generate the display content of screen 103. Although not shown in FIG. 1, touchscreen device 104 contains a GPU that is regularly used for rendering the display content of screen 111. At times and when needed, some parts or the entire display content of screen 111 may be created by the remote GPU, not shown in FIG. 1, housed in CPU 100 and transmitted over link 105. In one of the preferred embodiment of the present invention touchscreen device 104 also contains a CPU, not shown in FIG. 1, working together with CPU 100 to form a loosely-coupled multiprocessor computing system. In another exemplary embodiment of this invention the operating system is hosted on CPU 100, managing touchscreen device 104 as an accessory. In one preferred embodiment of the present invention that uses a loosely-coupled multiprocessor computing system configuration, less computation-demanding applications may be selectively processed on the native CPU alone to reduce the communication and data transfer load, especially when only the local display screen is needed for that application.

Depending on the application and user preference display screens 103 and 111 may be used in different modes. For example, in the extended display mode the two screens are used in a side-by-side fashion to effectively extend the border of screen 103 in any one of the 4 possible directions, where mouse 108 may be the preferred device for controlling the cursor visible only in one of the screens at any given time. In the duplicate display mode, the display content of screen 111 is a copy of a sub-region of display 103. And, in the independent display mode, the two screens are used as independent displays for user to utilize on a per-application or per-event basis, for example. FIG. 1 shows an example of the duplicate display mode, where a rectangular sub-region 110 of screen 103 is selected by user and a copy of that sub-region is displayed on screen 111. Using a variety of methods available to device 104, including touching, gesturing and cursor control, for example, user may zoom in on any specific area of screen 103 and review the details on touchscreen device 104 without changing the content on display unit 101. Similarly, user may also zoom out to get a greater perspective view on screen 111. Depending on the display mode and the application, other methods for control and manipulation of the display contents of screen 103 and screen 111 may also be available. For example, in one exemplary embodiment of the present invention the two screens 103 and 111 are used in the independent display mode to display the same view point of the same object, where the rendering properties of the graphics on each screen are controlled independently. That is, with the help of multi-threading programming and the touchscreen device native GPU, not shown in the drawing, the scaling, lighting, shading, color, and resolution, for example, for each of the screens can be independently adjusted, even when the rendering are based on the same data source. When the entire or a specific part of the displayed graphics of the two screens are rendered based on either different parts of a data source or data sources that may be arranged in a common space, either real or virtual, it is helpful to visualize and keep track of the relationship of the parts or the data sources either in the original or a transformed space on either screen. In an exemplary embodiment of the present invention as shown in FIG. 1, an overlay navigation map 112 that represents a scale-down version of the entire screen 103 is displayed at the upper left corner of screen 111. A properly scaled small rectangle 113 called the hot zone selector (HZS) is placed in navigation map 112 to represent the sub-region 110 that is currently displayed on display screen 111. Landmarks and location related information, not shown in the drawing, may also be displayed in navigation map 112, supported by interface mechanism for user to set, edit and store information and to control and manipulate the graphics display on either screen by touching, gesturing or cursor control, for example. Although not shown in FIG. 1, the touchscreen device 104 also contains a gyroscope for determining its physical orientation in the real 3D space so that the screen display can be automatically adjusted to match the viewing angle defined by the present orientation of touchscreen device without user intervention. Although not shown in the drawing, device 104 in FIG. 1 may contain other components such as a digital camera module or a GPS module, for example, to further expand the overall functionality and convenience of the system.

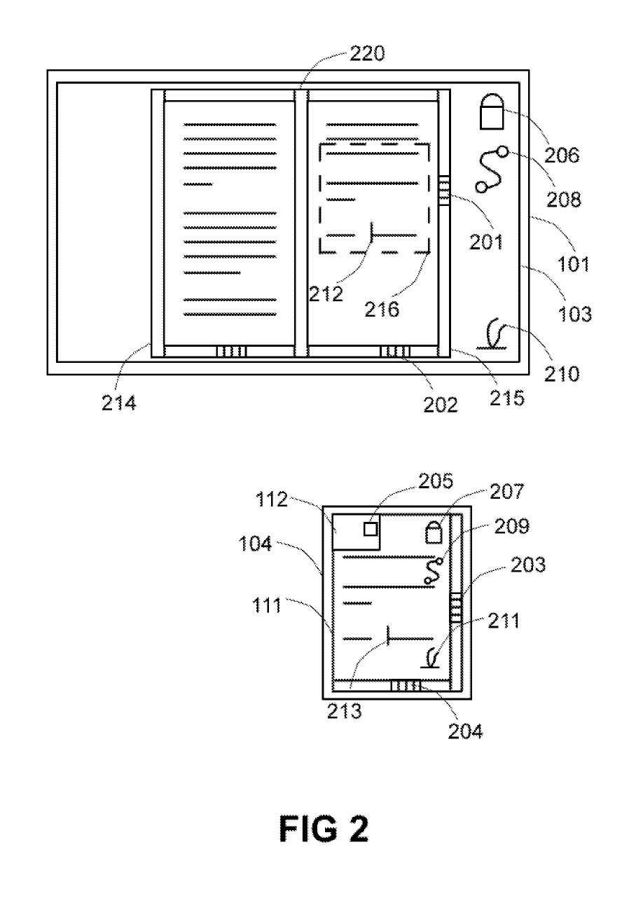

FIG. 2 shows an exemplary embodiment of screen 103 and screen 111 in FIG. 1 for an electronic document processing application. In FIG. 2 an electronic document is displayed on screen 103 in a 2-page landscape mode application window 220, in which pane 214 and pane 215 represent two adjacent pages of a document. A specific sub-region, outlined by marker 216 in pane 215, is displayed on screen 111 of device 104. A navigation map 112 on screen 111 shows the relative size and location of screen 111 in window 220. User may use touching, gesturing, mouse 108 or dedicated keys in keyboard 106 to operate scroll bars 201, 202, 203 and 204 so as to change the page displayed in panes 214 and 215. User may also use marker 216 or HZS 205 in navigation map 112 to change the size or re-select the sub-region of 216. At user's command, marker 206 may be turned on or off or displayed in different styles; such as: using a semi-transparent border line, using 4 semi-transparent corners or as a semi-transparent mask, for example. Several other features are also provided on either or both screens to improve performance and operation convenience. For example, the screen locks 206 and 207 on 103 and 111, respectively, may be used to prevent the present pages display in 214 and 215 or the sub-region displayed in 111 from being changed. The screen synchronization indicators 208 and 209 on 103 and 111, respectively, are used to show the data freshness and synchronization condition of the rendering data sources of screens 103 and 111, for example. The preferred input method (PIM) indicators 210 and 211 on 103 and 111, respectively, aid user in suggesting the preferred input methods for completing the present task. For example, when the cursor on screen 103 is positioned over an edit-protected region of the document and the two screens are operated in the duplicate display more, PIM indicators 210 and 211 may both suggest the mouse and the keyboard to be used for general document position control. And, when cursor 213 on screen 111 is positioned over a user-input field for hand-written signature input and that screens 103 and 111 are in the screen synchronization mode, PIM indicators on both screens may suggest the touch input method to be used for that entry. Although not shown in the drawing, a wireless stylus may be connected to device 104 for hand-writing input. In such event, PIM indicator 211 may suggest the wireless stylus, which is not shown in the drawing, as the most suitable input for that entry. In the present exemplary embodiment of the invention, PIM information may be inserted into the document at editing time and recorded as part of the information associated with a landmark, which may be assigned with appropriate access level setting and holding a status information field. The landmarks not only show up in navigation map 112 at user's discretion, they also help ensure that a pre-defined process flow is followed and completed before that document can be signed-off, for example. Although not shown in the drawing, the system may even disable a device that is inappropriate for the task at hand. For example, the system may warn and even disable keyboard 106 when user attempts to use keyboard 106 to complete a hand-written signature field in the document.

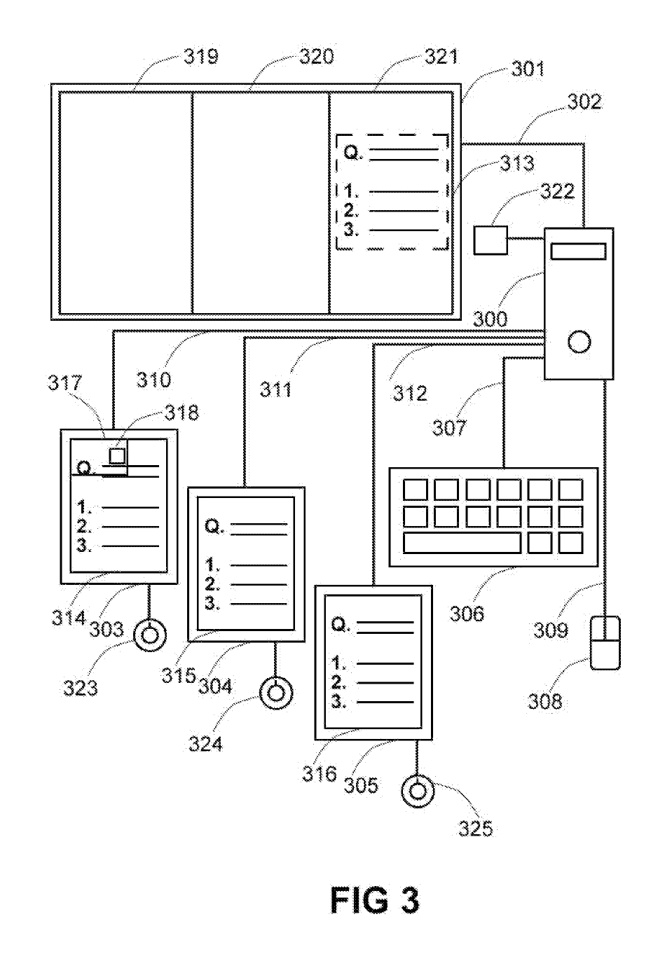

FIG. 3 shows another exemplary embodiment of the present invention where three touchscreen devices 303, 304, and 305 are connected to CPU 300 by wired or wireless links 310, 311 and 312, respectively. A large size touchscreen unit 301 is operationally connected by cable 302 to CPU 300, which also contains a GPU and a memory unit, both not shown in the drawing. In FIG. 3, display unit 301 may be a capacitive touchscreen connected to CPU 300 by cable 302. Alternatively, unit 301 may be a projector based virtual whiteboard unit, where cable 302 would connect CPU 300 to a projector, which is not shown in FIG. 3, to project the video signal produced by CPU 300 onto the whiteboard surface 313. In FIG. 3 CPU 300 is also connected to keyboard 306 by link 307, which may be wired or wireless, and to mouse 308 by link 309, which may be wired or wireless. Some or all of the touchscreen devices may have a built-in CPU and/or GPU, which are not shown in FIG. 3. Wireless receiver 322 is functionally connected to CPU 300 and receiving signals from wireless clickers 323, 324 and 325, which are functionally connected to 303, 304 and 305, respectively. Depending on the application and the setup, touchscreen devices 303, 304 and 305 may be selectively activated and assigned with different levels of operation privileges at a given time. For example, in an audience response application, each touchscreen device is assigned to an audience for independent use and screen 313 is sub-divided into 3 sub-regions: panel 319, panel 320 and panel 321. The application host may use mouse 308, keyboard 306 and touchscreen 301 to control and manage the application, including the display contents and the operation limitations of touchscreen devices 303, 304 and 305. When needed, one of the touchscreen devices may be assigned to and used by the application host to manage and control the application. When touchscreen device 303 is used as an application host control device an overlay navigation map 317 may be displayed on screen 314. The application host may use HZS 318 to select and control the display content of each touchscreen device individually or as a group. When proper application privileges are given by the application host, device 304 and device 305 may have limited control of their own display screen content as well as accessing and editing the content on 313. For example, when the present exemplary embodiment is used for product development focus group study, the application host may keep full control of the display content of all touchscreen devices during the presentation. And, during audience feedback collection, the application host may allow the audience touchscreen devices to access and display any presentation material on their local screens. Audience may use their touchscreen device to send answers and feedback to CPU 300. Alternatively, an infrastructure-independent wireless receiver 322 connected to CPU 300 may be used to receive audience data sent from clickers 323, 324 and 325 that are associated with touchscreen devices 303, 304 and 305, respectively, to offer a discreet, secure and public traffic-independent user data collection means that complements the touchscreen device. Although a local operational link is shown in FIG. 3 for communications between a clicker and its associated touchscreen device, in another exemplary embodiment of the present invention the association may be established and managed by the application software and that there would be no direct link between a clicker and its associated touchscreen device at all.

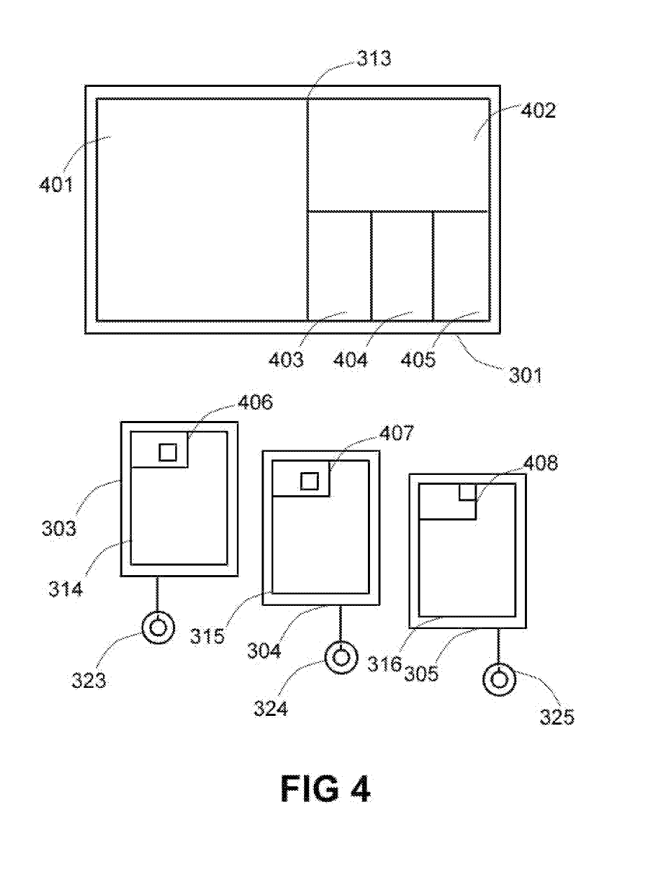

FIG. 4 shows another exemplary application of the embodiment of FIG. 3 for classroom interactive learning and collaboration activities involving a teacher and 3 students. The teacher may use touchscreen display 301, mouse 308, not shown in FIG. 4, or keyboard 306, not shown in FIG. 4, to manage the application executed on CPU 300, which is not shown in FIG. 4. Touchscreen devices 303, 304 and 305 are assigned to their designated students so that the students' activities and data input can be recorded into the corresponding individual accounts. In this embodiment of the present invention, the teacher may divide the display screen 313 into several sub-regions, each one with a specific access permission level. For example, in FIG. 4, screen 313 is sub-divided into 5 sub-regions: 401, 402, 403, 404 and 405, where sub-region 401 is used exclusively by the teacher for lecturing and presenting lesson material to the students as well as managing the application and the student device. Sub-region 402 is used as a general-purpose whiteboard, accessible to teacher and all three touchscreen devices: 303, 304 and 305 for collaborative activities, for example. Depending on the access permission setting, the students may use their assigned touchscreen devices, or, alternatively, a second wireless input means such as a mouse, for example, that are not shown in the drawing, to create, edit, modify and control contents displayed in sub-region 402 simultaneously or sequentially so that presentation, collaboration and discussions can be conducted without even leaving their seats, for example.

In FIG. 4, each of the sub-regions 403, 404 and 405 is assigned exclusively to one touchscreen device for individual work development, sharing and presentation. During lecturing, the teacher may set all touchscreen devices to a display-only mode so that students can't choose or modify the screen content of their display devices. At the beginning of a discussion session or during a review session, the teacher may activate the posting mode to give permission to some or all touchscreen devices to post questions or notes to their designated exclusive sub-regions on screen 313 using the touchscreen device, for example. During an open discussion session, the teacher may activate the discussion mode to give some or all touchscreen devices access to sub-region 402 so that they may interact with each other and with the teacher in the shared sub-region 402 through free-hand drawing and typing, for example. In the student presentation mode, greater permissions are given to the presenting student's touchscreen device to control some of the teacher level application functions that would not be allowed normally. In the test mode, all touchscreen devices are limited to test-taking related functions, such as typing, free-hand drawing and gesturing, for example. In the clicker mode, additional to using clickers 323, 324 and 325 each student may use his assigned touchscreen device to select from multiple choices or compose a short text answer and then submit it to the host computer. In one exemplary embodiment of the present invention a table style multi-choice selection panel is displayed on the touchscreens for the students to select and submit their answers by touching the corresponding table cell. In another exemplary embodiment of the present invention a dedicated local region is displayed on the touchscreens for the students to select and submit their answers using gestures. That is, each student makes specific gesture corresponding to the answer he wishes to submit inside the gesture answer pad area on his touchscreen first. The touchscreen device local CPU, not shown in FIG. 4, would then translate the gesture into the answer code before sending it to CPU 300. Although not as intuitive in operation, the gesture input method is more discreet and space-saving than the touch table method. Alternatively, clickers 323, 324 and 325 may be replaced by a multi-function, multi-mode handheld super input device like the invention disclosed in U.S. patent application Ser. No. 13/472,479, not shown in the drawing, to offer both precision control of the designated cursor on screen 313 and the touch position on the touchscreen, in addition to the clicker functions, all without the need of a supporting infrastructure.

Although not shown in FIG. 4, the teacher may use another touchscreen device similar to 303, 304 or 305 together with other available input mechanism in this exemplary embodiment of the present invention, to manage and control the application for greater mobility and input flexibility. Alternatively, touchscreen device 303, for example, may be assigned to function as an application control device, where a navigation map 406 may be used to control and manipulate the graphics display on all touchscreens. Similarly, with proper permission given, touchscreen devices 304 and 305 may also use their own navigation maps 407 and 408, respectively, to select and manipulate a specific area of screen 313 to be displayed on their own screen, for example.

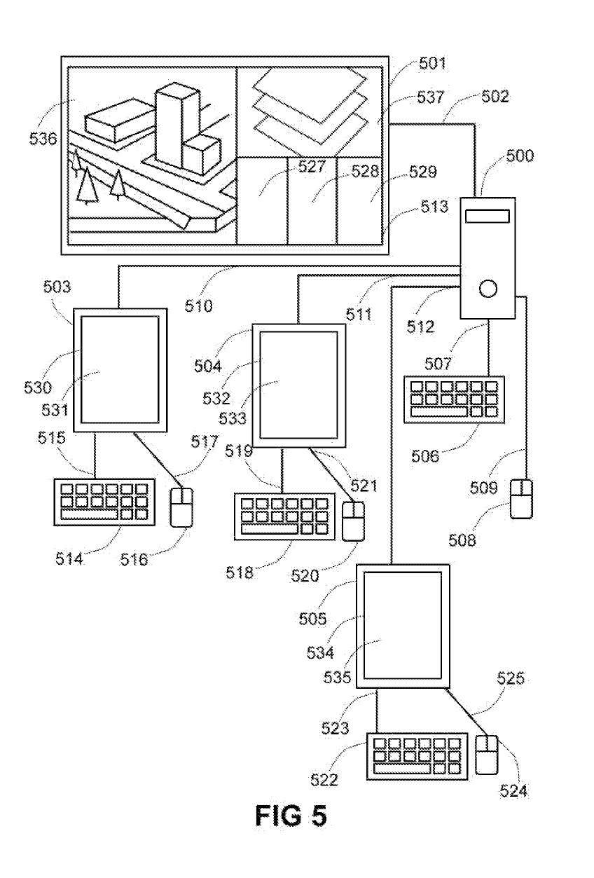

FIG. 5 shows another exemplary embodiment of the invention, where touchscreen devices 503, 504 and 505 are connected to CPU 500 by wired or wireless links 510, 511 and 512, respectively. Although not shown in the drawing, all of the touchscreen devices have a built-in CPU, a GPU and a memory unit, working with CPU 500 to form a loosely-coupled multiprocessor computing system. A larger size display unit 501 is operationally connected to CPU 500 by link 502, which may be weird or wireless. CPU 500 is also connected to keyboard 506 by link 507, which may be wired or wireless, and to mouse 508 by link 509, which may be wired or wireless. In this exemplary embodiment each of the touchscreen devices is also connected to a keyboard and a mouse. Depending on the application and its configuration, some or all of the touchscreen devices 503, 504 and 505 may be activated at a given time. For example, when this exemplary embodiment is used for a collaborative design application by a team of designers, each team member may use his/her touchscreen devices to participate in a multi-dimensional and multi-scale design session concurrently. The team lead, also taking the role as the application manager, may use mouse 508 and keyboard 506 to control the application as well as the functions and display contents of touchscreen devices 503, 504 and 505. Alternatively, one of the touchscreen devices may also be used as an application control device for the application manager to manage the application as well as the functions and display contents of other touchscreen devices. In one of the preferred embodiment of the invention display screen 513 is sub-divided into 3 different types of display areas, implemented as window panes: root, shared and private, where the display content and property of the root type areas are exclusively controlled by the application manager through mouse 508, keyboard 506 and any other designated application managing input devices, such as one of the touchscreen devices, for example. The shared type display areas are accessible to and shared by all authorized touchscreen devices, including their operationally connected HID devices. And, under the overall control of the application manager, the private type display areas are managed and controlled by one designated touchscreen device together with its operationally connected HID devices only. FIG. 5 shows an exemplarily embodiment of the present invention implemented with a multi-threading, multi-processor software to be used for an urban planning application. A three-dimensional rendering of the present design under development is displayed in window pane 536 on screen 513. A stack of different vector maps of a localized area is shown in pane 537, where each of the touchscreen devices may be assigned to work on a specific vector map in the stack processing one or more software threads on the native CPU, for example. The display content 531 of screen 530 is constantly updated by the native GPU while the vector map is being edited by touchscreen device 503 using touch input, mouse 516 and keyboard 514. The updating of the display content in pane 527, which is assigned to touchscreen device 503, to reflect the present design data stored in the RAM of CPU 500 may be managed by a thread manager or an event manager of the application software, for example, that monitors and manages the data editing processes executed on device 503 and triggers a screen update event in pane 527 when a programmed condition is met. When the vector map data editing processes are completed on 503 and the RAM is updated, the display contents in pane 536 and pane 537 get updated correspondingly. Similarly, device 504 and device 505 may work on other vector maps or tasks and update the relevant screen contents in parallel.

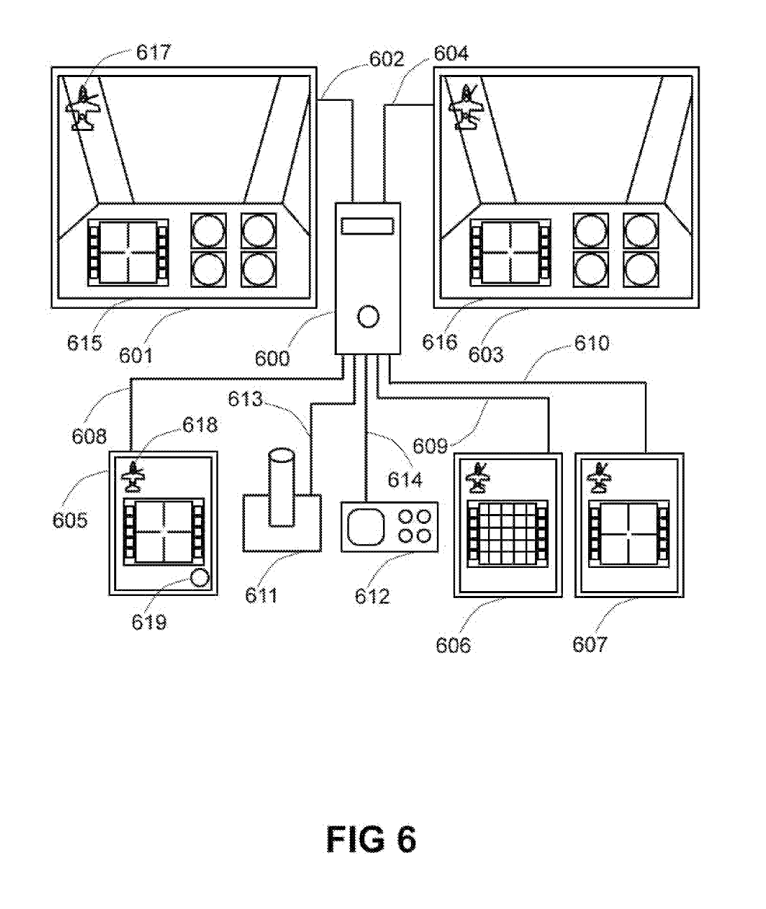

FIG. 6 shows another exemplary embodiment of the invention, where CPU 600 is connected to a large size display unit 601 by link 602, which may be wired or wireless. CPU 600 is also connected to a second large size display unit 603 by link 604, which may be wired or wireless. Although not shown in the drawing, CPU 600 also houses two GPUs, responsible for rendering the display content on screens 615 and 616. Touchscreen devices 605, 606 and 607, each containing a CPU and a GPU that are not shown in FIG. 6, are connected to CPU 600 by wired or wireless links 608, 609 and 610, respectively. Two HIDs: a joystick 611 and a game controller 612 are also connected to CPU 600 by wired or wireless links 613 and 614, respectively. Depending on the application and its settings, some or all of touchscreen devices 605, 606 and 607 may be activated at a specific time. Further details of this exemplary embodiment of the present invention are illustrated using the example of a team based air combat game, whose core memory is kept and main thread is hosted on CPU 600. The game application is played by a two opposing teams, each team comprising a pilot and at least one other team member playing as a flight crewmember. In FIG. 6, the front view of the pilots', including the cockpit instruments, are displayed in units 601 and 603. The pilots may use devices 611 and 612 to control the aircrafts and perform other game play operations. A non-pilot team member may use one or more of the touchscreen devices 605, 606, and 607 to play one or multiple roles in the game in collaboration with other team members. Additional input devices, such as keyboard, mouse and specialized game controllers, which are not shown in the drawing, may also be operationally connected to CPU 600 or any touchscreen devices to be used in game play. Depending on the game mode selection or the player's role, for example, a crewmember's touchscreen may display his front view from inside the aircraft with a selected instrument or a piece of equipment that he wishes to control, for example. When a player is using a touchscreen device to control the game play, additional to the built-in touch and gesture-based functions and commands, he may also define personalized gesture functions and commands to be used in a moveable localized sub-region, called the gesture pad, displayed on his device. For example, when a user-defined gesture is applied to area 619 on 605, that gesture is converted into a user data or command code, for example, by touchscreen 605's CPU, not shown in FIG. 6, and then processed accordingly.

Display content on screen 615 and 616 are managed by the pilots of the teams. In FIG. 6, the gunner's targeting instrument displayed on device 605 is also displayed on screen 615. Additionally, an airplane and crew status map 617 is also displayed on screen 616 to keep the pilot up-dated on the present condition of the vehicle and the crewmembers. Similarly, an airplane and crew status map 618 is also displayed on device 605. When a team member sends out a warning message or an alert signal, maps 617 and 618 will generate a corresponding visual sign to reflect the urgent event. Unlike a traditional game console system, where the game software and the graphics are executed and created by centralized CPUs and GPUs, the exemplary embodiment of the present invention in FIG. 6 uses local CPUs and GPUs for local processes and tasks. For example, following the decoding of a user-defined gesture applied to the gesture pad, the touchscreen device CPU sends the code to CPU 600 for system update while processing it in the local threads. According to the application, CPU 600 may send that code to other devices while processing it in the local threads that are affected by it occurrence. By synchronizing the application status, keeping the core data set up-to-date and ensuring user inputs and commands are quickly and surely transmitted over to all affected CPUs, the graphics content of each display may be generated entirely by the local GPU, thus significantly reduces the chances of video lag or the requirements of extreme communication infrastructure, especially when a graphics-intensive game is played. Although not shown in FIG. 6, touchscreen devices 605, 606 and 607 also contain a gyroscope for determining their physical orientation in the real 3D space so that the screen display can be automatically adjusted according to the viewing angle defined by the present orientation of touchscreen device without user intervention.

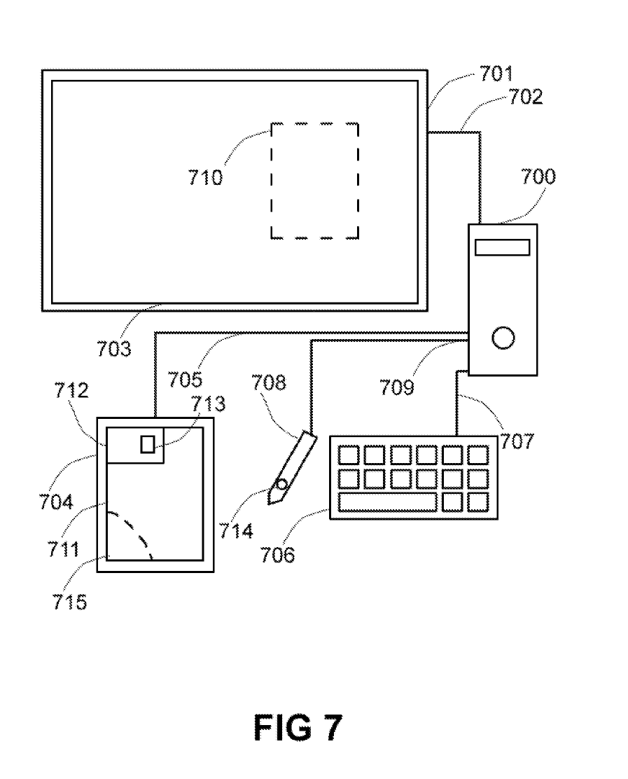

FIG. 7 shows another exemplary embodiment of the present invention. CPU 700 is connected to a large size display unit 701 by link 702, which may be wired or wireless. Touchscreen device 704 is connected to CPU 700 by link 705, which may be wired or wireless. CPU 700 is also connected to a keyboard 706 by link 707, which may be wired or wireless. A multi-mode handheld device 708 working as either a touchscreen stylus or a cursor control device is connected to CPU 700 by wireless link 709. Alternatively, handheld device 708 may be functionally connected to touchscreen device 704 instead. The graphics content of screen 703 is generated by a GPU unit, not shown in FIG. 7, functionally connected to and housed in CPU 700. The graphics content of screen 711 of touchscreen device 704 is generated by a native GPU, not shown in FIG. 7. Additionally, touchscreen device 704 may also have a built-in CPU, not shown in FIG. 7, working with CPU 700 to form a loosely-coupled computing system. Depending on the application, different software threads or processes of an application may be executed on the 2 CPUs concurrently in a synchronized fashion, either under the system management or by user setting. User may use various commands and input methods through devices 704, 706 and 708, for example, to control the relationship between the graphics contents of screen 703 and screen 711. That is, depending on the application and user preference display screens 703 and 711 may be used in different modes. For example, in the extended display mode the two screens are used in a side-by-side fashion to effectively extend the border of screen 703 in any one of the 4 possible directions, where device 708 may be the preferred device for controlling the cursor visible only in one of the screens at any given time. In the duplicate display mode, as shown in FIG. 7, the display content of screen 711 is a copy of a sub-region of display 703. And, in the independent display mode, the two screens are used as independent displays for user to utilize on a per-application or per-event basis, for example. In FIG. 7, a rectangular sub-region 710 of screen 703 is selected by user and a copy of that sub-region is displayed on screen 711. User may use a variety of methods available to device 704, including touching, gesturing and cursor control, for example, to zoom in on any specific area of screen 703 and review the details on touchscreen device 704 without changing the content on display unit 701. Using the native GPU on device 704, the rendering of screen 711 is a local operation. Similarly, user may also zoom out to get a greater perspective view on screen 711. Depending on the display mode and the application, other methods for control and manipulation of the display contents of screen 703 and screen 711 may also be available. For example, in one exemplary embodiment of the present invention the two screens 703 and 711 are used in the independent display mode to display the same view point of the same object, where the rendering properties of the graphics on each screen are controlled independently. That is, with the help of multi-threading programming and the touchscreen device native GPU, not shown in the drawing, the scaling, lighting, shading, color, and resolution, for example, for each of the screens can be independently adjusted, even when the rendering are based on the same data source. When the entire or a specific part of the displayed graphics of the two screens are rendered based on either different parts of a data source or data sources that may be arranged in a common space, either real or virtual, it is helpful to visualize and keep track of the relationship of the parts or the data sources either in the original or a transformed space on either screen. In an exemplary embodiment of the present invention as shown in FIG. 7, an overlay navigation map 712 that represents a scale-down version of the entire screen 703 is displayed at the upper left corner of screen 711. A properly scaled small rectangle 713 called the hot zone selector (HZS) is placed in navigation map 712 to represent the sub-region 710 that is currently displayed on display screen 711. Landmarks and location related information, not shown in the drawing, may also be displayed in navigation map 712, supported by interface mechanism for user to set, edit and store information and to control and manipulate the graphics display on either screen by touching, gesturing or cursor control, for example. Although not shown in FIG. 7, the touchscreen device 704 also contains a gyroscope for determining its physical orientation in the real 3D space so that the screen display can be automatically adjusted to match the viewing angle defined by the present orientation of touchscreen device without user intervention. Although not shown in the drawing, device 704 in FIG. 7 may contain other components such as a digital camera module or a GPS module, for example, to further expand the overall functionality and convenience of the system.

Additional to using handheld device 708 for cursor control, touch screen gestures performed under a specific cursor control mode may also be used for cursor control on a selected screen in FIG. 7. For example, while user touching surface 711 at the lower left corner 715 with a first finger and moves a second finger or stylus 708 outside of corner 715 on screen 711, he may control the screen cursor on either screen. Buttons 714 may be placed on the body of device 708 for mouse button functions. Alternatively, a small touch sensitive surface, not shown in FIG. 7, may be operated by pre-defined gestures to replace mechanical button functions. Further details of device 704 are disclosed later.

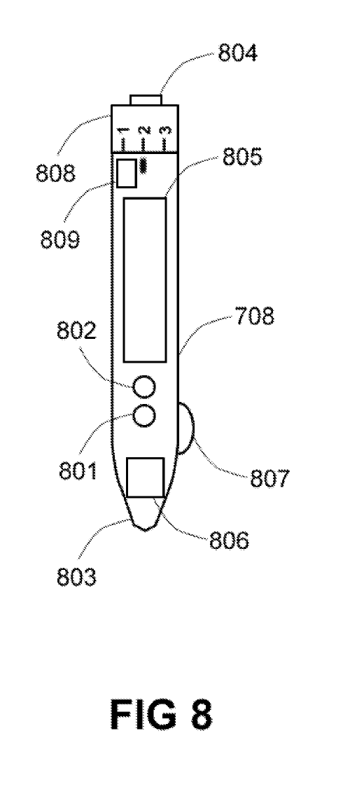

FIG. 8 shows an exemplary embodiment of handheld device 708. In FIG. 8, device 708 has a wireless transmission module 809, a barrel-shaped body and a capacitive stylus tip 803. Device 708 also has an optical navigation module 806 placed near tip 803 so that the same end works for both the stylus mode and the mouse mode. Alternatively optical navigation module 809 may be placed on the opposite end of stylus tip 803 and implemented with a wedge-shape profile, similar to the design disclosed in U.S. Design Pat. No. D479,842, to allow for operation even on soft and curved surfaces. Scroll wheel 807 operates a rotary encoder that is not shown in the drawing. Additionally, scroll wheel 807 also activates a vertical force-operated switch and a horizontal force-operated switch; both are not shown in FIG. 8. The vertical force-operated switch, not shown in FIG. 8, works as the third mouse button and the horizontal force-operated switch, not shown in FIG. 8, works as a mode selector. User uses mode selector 807 to select the device operation mode that offers the desired behavior and functions of device 708. For example, in the mouse mode navigation module 806 is powered on and device 708 works like a pen-shaped computer mouse. In the mouse mode, buttons 801 and 802 perform the mouse buttons function, scroll wheel 807 works as the mouse scroll wheel and actuator 804 resets the mouse cursor speed according to rotary encoder 808 setting. In the stylus mode, optical navigation module 806 is turned off so that device 708 no longer controls the mouse cursor. And, in the clicker mode, user may press actuator 804 to send out a user data signal to a receiver, which is not shown in the drawing, according to rotary encoder 808 setting or use button 801 to display the current user data selection in display screen 805 before pressing button 802 to send out that data. In one of the preferred embodiment of the present invention screen 805 also shows the present device mode. Alternatively, a mode indicator light, not shown in FIG. 8, may be used to show the present device mode. In FIG. 8, device 708 is implemented as a simple standard HID device, using the invention disclosed in U.S. patent application Ser. No. 13/472,479 for clicker function implementation. In another exemplary implementation, device 708 may be implemented as a composite HID device, sending the clicker mode user data out as a keyboard signal, for example. Although not shown in FIG. 8, device 708 may contain a memory unit that stores the last 50 user data sent out from device 708 and the last 50 mouse cursor strokes. Additionally, device 708 may also contains a computing unit, no shown in FIG. 8, for converting pre-defined mouse gestures into data or commands before sending them out.

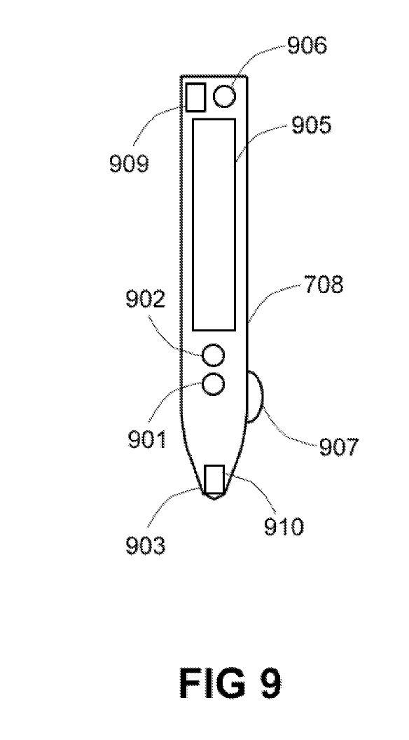

FIG. 9 shows another exemplary embodiment of device 708. In FIG. 9, device 708 has a wireless transmission module 909, a barrel-shaped body and a capacitive stylus tip 903. Device 708 also has a gyroscope 906 placed near the opposite end of tip 903 so that it may function as a virtual joystick by measuring the orientation change using tip 903 as the pivot and the barrel-shaped body as the lever, when the mouse mode is turned on and the tactile sensor 910 is triggered. Scroll wheel 907 operates a rotary encoder that is not shown in FIG. 9. Additionally, scroll wheel 907 also activates a vertical force-operated switch and a horizontal force-operated switch; both are not shown in FIG. 9. The vertical force-operated switch, not shown in FIG. 9, works as the third mouse button and the horizontal force-operated switch, not shown in FIG. 9, works as a mode selector. User uses mode selector 907 to select the device operation mode that offers the desired behavior and functions of device 708. For example, in the mouse mode navigation module 906 is powered on and device 708 works like a pen-shaped computer mouse. In the mouse mode, buttons 901 and 902 perform the mouse buttons function, scroll wheel 907 works as the mouse scroll wheel. In the stylus mode, optical navigation module 906 is turned off so that device 708 no longer controls the screen cursor. And, in the clicker mode, user uses scroll wheel 907 to select the desired answer from the list displayed on screen 905 before pressing button 902 to send the answer out. Although not shown in FIG. 9, device 708 may contain a memory unit that stores the last 50 user data sent out from device 708 and the last 50 screen cursor strokes, for example. Additionally, device 708 may also contains a computing unit, no shown in FIG. 9, for converting pre-defined mouse gestures into data or commands before sending them out.

While the invention has been described, for illustrative purposes and in connection with what may be considered most practical and preferred embodiment at the present time, it is to be understood that the present invention is not to be limited to the disclosed embodiment, but on the contrary, is intended to cover various modifications and equivalent arrangements included within the spirit and scope of the appended claims.

What is claimed is:

1. A non-session based computing system, comprising:
a first CPU;
a memory unit;
a first display unit comprising a GPU and a display surface with touch-input capability operationally connected to said first CPU; and
a second display unit with a display surface at least twice the size of said first display unit display surface operationally connected to said first CPU,
wherein said first display unit accepts user input for controlling said first CPU, the relationship between display contents of said first and second display units and at least one point of interest control means uniquely identifiable for said first display unit on said second display unit,
wherein said point of interest control means include at least screen cursor, touch input and digitizer pen input.

2. In claim 1, said system further comprising a HID operationally connected to said first CPU.

3. In claim 1, said first display unit further comprising a CPU and at least one of a memory unit, a gyroscope, a GPS unit, an imaging module, one or more accelerometers or an electronic compass.

4. In claim 1, said first display unit detecting a specific touch event for transmitting a pre-determined code to said first CPU.

5. In claim 1, said system further comprising one or more touch-input display units.

6. In claim 5, each said touch-input display unit uniquely controlling at least one pixel of display content of said second display unit.

7. In claim 5, each said touch-input display unit controlling at least one point of interest control means with unique display unit identification on said second display unit,
wherein said point of interest control means include at least screen cursor, touch input and pen input.

8. A method for operating a non-session based computing system comprising a processing unit, a first operationally connected display unit, one or more operationally coupled touchscreen devices, a cursor control device and a keyboard, the method comprising the steps of:
establishing a unique identity for each said touchscreen device and said cursor control device;
defining a display sub-region in said first display unit and setting access and operation permission to said sub-region for each said touchscreen device and said cursor control device;
accepting user inputs to said touchscreen devices and cursor control devices based on associated access and operation permission settings; and
updating display content of said first display unit and said touchscreen devices according to accepted user inputs.

9. In claim 8, wherein said computing system accepting user inputs to said touchscreen devices step comprising the steps:
applying a pre-determined signal means on each said touchscreen device and cursor control device according to associated access and operation permission settings;
screening out user inputs to said touchscreen devices and cursor control devices according to associated access and operation permission settings; and
accepting remaining user inputs to said touchscreen devices and cursor control devices.

10. In claim 9, wherein said computing system accepting remaining user inputs to said touchscreen devices and cursor control devices step comprising the steps:
detecting a pre-defined user touch-input event on each permitted touchscreen device and a pre-defined cursor-related input event on each permitted cursor control device,
converting the detected pre-defined user touch-input event into a pre-determined code and the detected pre-defined cursor-related input event into a pre-determined code and sending said converted codes to said processing unit; and
accepting said converted codes as user input signal from associated touchscreen device and cursor control device.

11. In claim 9, wherein said screening out user inputs to said touchscreen devices and cursor control devices according to associated access and operation permission settings step comprising at least one of the steps:
disabling user input function of the device,
removing the identity representation of the device from the display of said first display unit, and
ignoring user input to the device.

12. A hand-operated input device comprising:
a shaft;
a wireless transmission module;
an actuator disposed along the shaft;
a first tip at the longitudinal end of the shaft for operating on a touchscreen device by touching the screen; and
a second tip for controlling the cursor on a display coupled to a processing unit.

13. In claim 12, wherein said input device further comprises a mode selection means.

14. In claim 12, wherein said first tip and said second tip are on the same longitudinal end of said shaft.

15. In claim 12, wherein said input device further comprising at least one of a second button, a scroll wheel, a toggle wheel, a rotary encoder, a memory unit, a gyroscope, an accelerometer, an optical navigation module and a touch sensitive surface.

16. In claim 12, wherein said first tip is sensitive to pressure.

17. In claim 12, wherein said second tip has a wedge shape profile.

18. In claim 12, wherein said input device further comprising a means to generate an event-signal based chorded signal without user composing manually.

19. A non-transitory computer-readable medium having instructions, the instructions comprising:
instructions for detecting or identifying a first display unit operationally connected to a processing unit;
instructions for detecting and identifying additional touch-input display devices and cursor control devices operationally connected to said processing unit and establishing a unique identity for each said detected touch-input display device and cursor control device;
instructions for setting up a display sub-region on said first display unit;
instructions for setting up access and operation permission to said display sub-region of said first display unit for at least one said detected touch-input display device or cursor control device; and
instructions for generating display content of said first display unit according to user input to said detected touch-input display devices and cursor control devices and associated access and operation permission settings.

20. In claim 19, wherein said instructions for generating display content of said first display unit according to user input to said detected touch-input display devices and cursor control devices and associated access and operation permission settings comprising:
instructions for generating a pre-determined signal on each said detected touch-input device according to associated access and operation permission to said display sub-region;
instructions for screening out inputs from input devices according to associated access and operation permission to said display sub-region; and
instructions for generating display content of said first display unit according to accepted inputs.
